(19) United States
(12) Patent Application Publication
(10) Pub. No.: US 2020/0295491 A1
(43) Pub. Date: Sep. 17, 2020

(54) HIGH PERFORMANCE ELECTRONIC INTERPOSER

(71) Applicant: Velegrity LLC, Harrisburg, PA (US)

(72) Inventor: Douglas Andrew Neidich, Harrisburg, PA (US)

(21) Appl. No.: 16/351,051

(22) Filed: Mar. 12, 2019

(51) Int. Cl. H01R 13/24

(52) U.S. Cl. CPC H01R 13/2435; H01R 13/2478

(57) ABSTRACT

A systems for creating an electrical connection between two substrates is disclosed herein in various embodiments. In one embodiment, the system may include an upper substrate, a lower substrate, and a dielectric plate. As disclosed herein, the dielectric plate may have one or more passages with a first end wall and a second end wall. One or more contacts may be inserted in to the one or more passages. The one or more contacts may have an upper portion with a dome protrusion and a lower portion with a dome protrusion. When the one or more contracts is inserted into the one or more passages, and the upper and lower substrates are put into place, the contracts compress and create an electrical path. Moreover, various other embodiments may be further disclosed herein.

### TECHNICAL FIELD

The present disclosure relates to interposer assemblies used for forming electrical connections between spaced contact pads on circuit members.

### BACKGROUND

Interposer assemblies form electrical connections between contact pads arranged in very close proximity to each other. The pads are generally arranged on a grid spaced equidistantly from each other. Each assembly may include thousands of contacts. Thus, the contacts must establish a reliable electrical connection with the pads when they are placed between circuit members. In many cases, if a single contact fails to make a reliable connection, it could render the entire assembly useless.

Typically, contacts used in assemblies include contact surfaces, which mechanically engage the contact pads and form electrical connections. Conventional formed metal contact interposer assemblies have a surface contacts which engage a mating pad at an upper and lower interface thereby forming an electrical connection between the two pads along a single conduction path.

What is needed is an interposer assembly design that can create a higher-signal-speed connection by means of dual conduction paths. As discussed herein, various improvements are provided to enhance the function and reliability of interposer assemblies.

### BRIEF DESCRIPTION OF THE DRAWINGS

Some embodiments are illustrated by way of example and not limitation in the figures of the accompanying drawings in which:

FIG. 1 depicts a top view of contact assembly according to an embodiment.

FIG. 2 depicts a side view of a contact according to an embodiment.

FIG. 3 depicts a front view of a contact according to an embodiment.

FIG. 4 depicts a top view of a contact according to an embodiment.

FIG. 5 depicts a sectional view taken along line 1-1 of FIG. 1 illustrating a contact in position to be inserted in a through passage in an interposer plate according to an embodiment.

FIG. 6 depicts a sectional view taken along line 1-1 of FIG. 1 illustrating the contact in the plate according to an embodiment.

FIG. 7 depicts another sectional view taken along line 1-1 of FIG. 1 illustrating the assembly positioned on a lower substrate according to an embodiment.

FIG. 8 depicts another sectional view taken along line 1-1 of FIG. 1 illustrating an upper substrate on the top of the plate supported by a contact with the contact partially compressed according to an embodiment.

FIG. 9 depicts another sectional view taken along line 1-1 of FIG. 1 illustrating the upper and lower substrates sandwiched onto the plate and the contact fully compressed to form two circuit paths according to an embodiment.

FIG. 10 depicts a front view of a contact according to another embodiment.

### DETAILED DESCRIPTION

The present description and claims may make use of the terms “a,” “at least one of,” and “one or more of,” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In addition, it should be appreciated that the following description uses a plurality of examples for various elements of the illustrative embodiments to further illustrate example implementations of the illustrative embodiments and to aid in the understanding of the mechanisms of the illustrative embodiments. These examples are intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the embodiments provided herein without departing from the spirit and scope of the present disclosure.

As used herein, the term “includes” means “comprises.” For example, a device that includes or comprises A and B contains A and B but can optionally contain C or other components other than A and B. A device that includes or comprises A and B may contain A and B, and optionally one or more other components such as C.

In accordance with the present invention, various embodiments of a high performance electronic interposer are disclosed herein. In previous solutions, an array of spring metal contacts would be retained in cavities within a molded plastic housing using a molded ramp feature in each housing cavity that engages a gap at the mouth of one or more C-shaped contacts. Various examples of previous designs may be found in U.S. Pat. Nos. 6,290,507; 6,730, 134; and 6,315,576.

As discussed herein, various improvements are possible over the above-listed designs. For example, in one embodiment, the contact is retained in the housing cavity by means of a molded ramp that engages a detent in the spine of the contact. Thus, in some embodiments, the front arms of the C-shaped contact are allowed to deflect freely in the cavity (i.e., without having to deflect along the molded ramp) during contact deflection.

In a further embodiment, the freely acting arms of the contact may have various improvements, such as, for example a tab-and-slot design, or matching offset protrusions. Thus, when pressure is applied to the contact (e.g., via dielectric plates), the mouth of the contact is closed, and the two ends securely interlock with each other. It should be understood that, although various specific examples may be used herein, the contact may sit within the interposer and between a variety of planar surfaces. Some non-limiting examples of planar surfaces may be circuit boards, flexible circuits, integrated circuits, and/or any other electronic surface that includes wiring and/or pads suitable for connection to another surface.

As would be understood by one skilled in the art, the interlocked ends of the contact arms ensure that the arms do not slip off of each other and/or that one arm does not flex or move more than the other. In some embodiments, when the contact arms meet, the force applied may cause the arms of the contact to deflect inward toward the center, thereby significantly adding to the contact's resultant normal force and meeting minimum standard normal force requirements for a low-voltage electronic connector. Thus, ensuring a secure connection between the two arms is critical not only for improved conductivity, but also to ensure that each contact maintains the proper required resultant force. The interlocked ends of the contact arms also ensure a consistent electrical path length, as compared to the variable electrical path length of a similar contact without interlocking ends and rather a ‘rolling’ contact end interface.

In a further embodiment, one or more domes may be placed at the upper and lower contact points of the contact. As discussed herein, such domes may allow for an increased point-contact force at the contact interface and for easier alignment with the one or more mating contact pads.

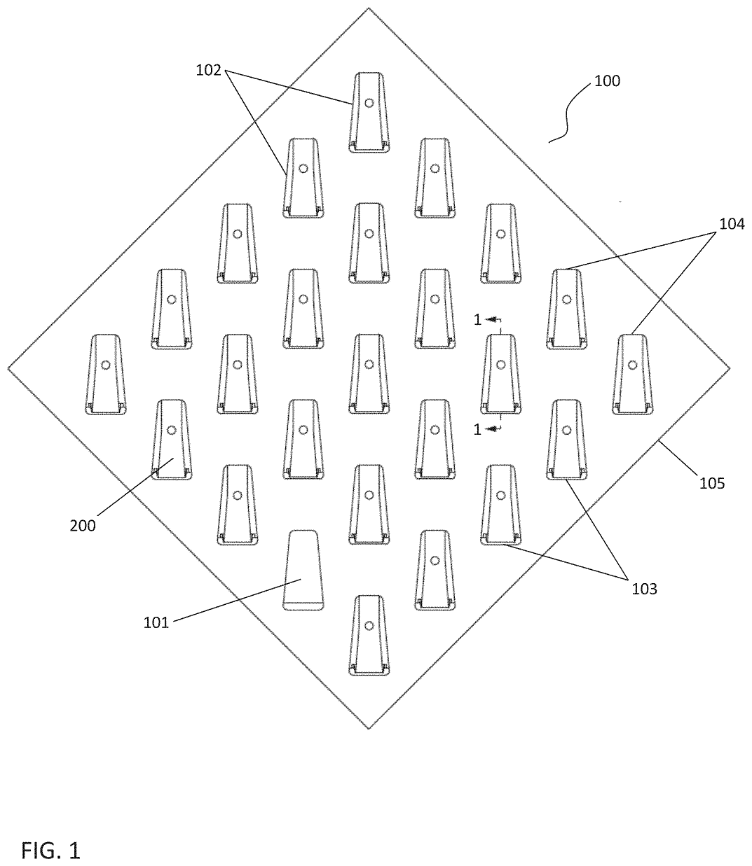

Referring now to FIG. 1, a top view of an interposer assembly 100 is shown. As illustrated in FIG. 1, each passage 101 may have a maximum width between side wall portions 102 at a first end wall 103 and a minimum width between the sidewall portions at a second end wall 104. It should be understood that various features, such as a protrusion or tip, may be discussed herein by reference to the first end wall 103 and/or the second end wall 104, but that these examples are for illustrative purposes only. Thus, the orientation and/or placement of a contact 200 may be discussed relative to the first end wall 103 and/or the second end wall 104; however, one of ordinary skill in the art will realize that alternative embodiments are possible in which the first end wall 103 represents the narrow end of the passage 101 and the second end wall 104 represents the wide end of the passage, or vice versa.

It should also be noted that although FIG. 1 shows one passage 101 as being empty, this is for illustrative purpose only. Generally, each passage 101 of the assembly 100 will contain a contact 200. Additionally or alternatively, some embodiments may exist wherein one or more passages 101 are left empty by design.

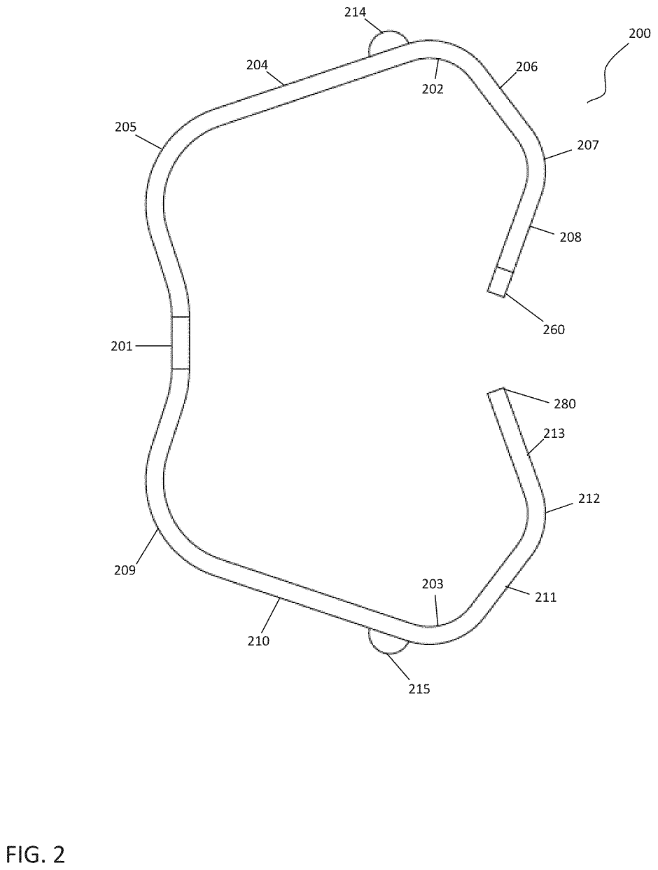

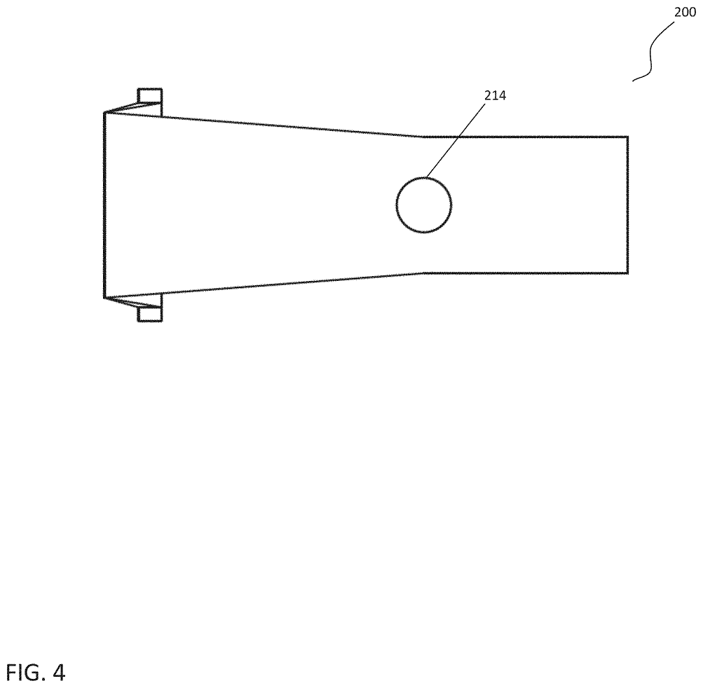

Referring generally to FIGS. 2, 3, and 4, in some embodiments, the contacts 200 may be stamp-formed from gold and nickel plated beryllium copper strip stock of uniform thickness. However, it should be understood that various other metals or metal alloys capable of meeting the conductive requirements of electronic circuitry may be used (e.g., silver, copper, gold, aluminum, zinc, nickel, brass, bronze, iron, platinum, steel, lead, stainless steel, or any combination thereof). In some embodiments, the stock may have a thickness between about 0.001 mm and about 0.1 mm. In another embodiment, the stock may have a thickness between about 0.04 mm and about 0.06 mm. Each contact 200 has a flexible vertical spine 201 with a rounded upper contact support 202 and a rounded lower contact support 203 at the ends of the spine.

In a further embodiment, one or more contacts may have a first upper flat spring arm 204 that angles upwardly and inwardly from an upper contact support 205 to the rounded upper contact support 202 at the top of the contact 200. In another embodiment, a second upper flat spring arm 206 may angle downwardly and outwardly from the rounded upper contact support 202 to an upper support bend 207 which faces away from the spine 201. A contact 200 may also have a upper end strip 208 that extends downwardly and inwardly from upper support bend 207 to an upper tip 260.

In a further embodiment, the contact 200 may be vertically symmetrical to either side of the center point of the spine 201, such that the lower half of the contact has a lower contact support 209, first lower flat spring arm 210, rounded lower contact support 203, a second lower flat spring arm 211, lower support bend 212, lower end strip 213 and a lower tip 280. In a further embodiment, the contact 200 may have a pair of domes (i.e., upper dome 214 and lower dome 215) provided on the opposed edges of rounded upper contact support 202 and rounded lower contact support 203.

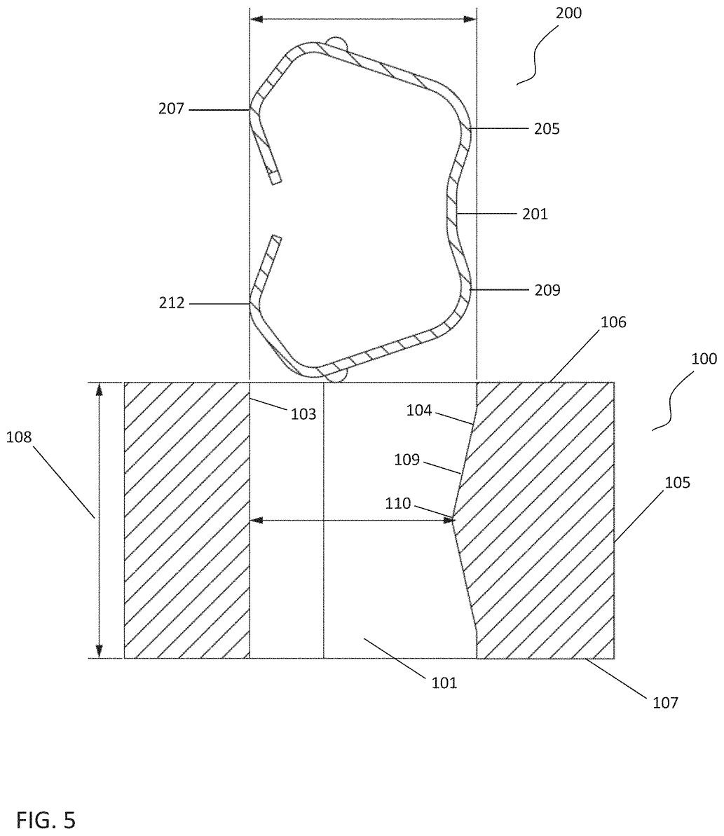

As shown in FIG. 5, in some embodiments, an interposer assembly 100 may have a flat dielectric plate 105 with parallel top and bottom surfaces 106 and 107 having a uniform thickness 108 and closely spaced contact passages 101 arranged in intersecting land grid array rows and columns (see FIG. 1 for detail). The plate 100 may have a thickness 108 between about 1.0 mm and about 2.0 mm. In a further embodiment, one or more formed metal contacts 200 may be positioned in the passages 101.

Referring generally to FIGS. 1 and 5, in some embodiments, each passage 101 in plate 105 may have a wide end wall 103 and an opposed narrow end wall 104. The wide end wall 103 may be flat and extend perpendicularly between the parallel top 106 and bottom 107 surfaces. The narrow end wall 104 may include a contact retention protrusion 109 which extends into passage 101. The protrusion 109 may have two flat and inwardly angled cam surfaces that meet to form a tip 110. In some embodiments, the tip 110 may be located equidistant between the top surface 106 and the bottom surface 107.

The flat cam surfaces on wall 104 extend from the tip 110 toward the top and bottom surfaces 106 and 107 at a shallow outward angle. As shown in FIG. 5, wall 103 is perpendicular to surfaces 106 and 107, and the width of passage 101 increases to either side of tip 110.

In a further embodiment, passages 101 have opposed sidewalls extending between end walls 103 and 104. In a further embodiment, each sidewall may include a flat portion extending perpendicularly between the top surface 106 and the bottom surface 107 and perpendicularly from one edge of wide end wall 103. A yet further embodiment may have flat, inwardly tapered sidewall portions extend from the edge of second end wall 104 away from first end wall 103. As illustrated in FIG. 1, each passage 101 has a maximum width proximate to one of the first 103 and second 104 end walls (e.g., the first end wall 103 as shown), and a minimum or reduced width proximate to the other one of the first 103 and second 104 end walls (e.g., the second end wall 104 as shown).

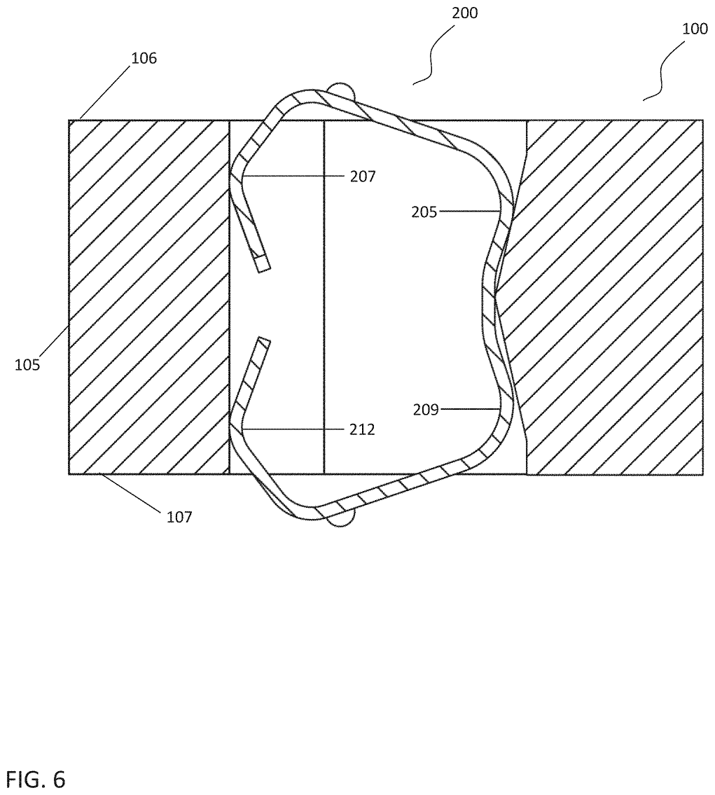

In some embodiments, the one or more contacts 200 may be inserted into one or more passages 101 by positioning a contact above a passage, as shown in FIG. 5, and then lowering the contact down into the passage to the position shown in FIG. 6. In one embodiment, during and after insertion, the contact 200 may be positioned such that the detent of the spine 201 encompasses and/or contacts the tip 110 of the protrusion 109. During insertion of the one or more contacts 200, the upper contact support 205 may move down along wall 104 and engage the upper cam side of protrusion 109, while the lower contact support 209 engages the lower cam side of the protrusion. In a further embodiment, the upper support bend 207 and the lower support bend 212 may slide down the first end wall 103, as shown in FIG. 6.

In some embodiments, the contact 200 may have a loose fit in passage 101 with limited free vertical movement. Accordingly, at least a portion of the upper contact support 205 and the lower contact support 209 may rest on a portion of wall 104, specifically the contact retention protrusion 109. In a further embodiment, at least a portion of the upper support bend 207 and the lower support bend 212 rest on a portion of wall 103. As shown in FIG. 6, the contact 200 is in a gravity down position with the upper contact support 205 resting on the upper cam side of protrusion 109 and lower contact support 209 resting on the lower cam side of protrusion 109.

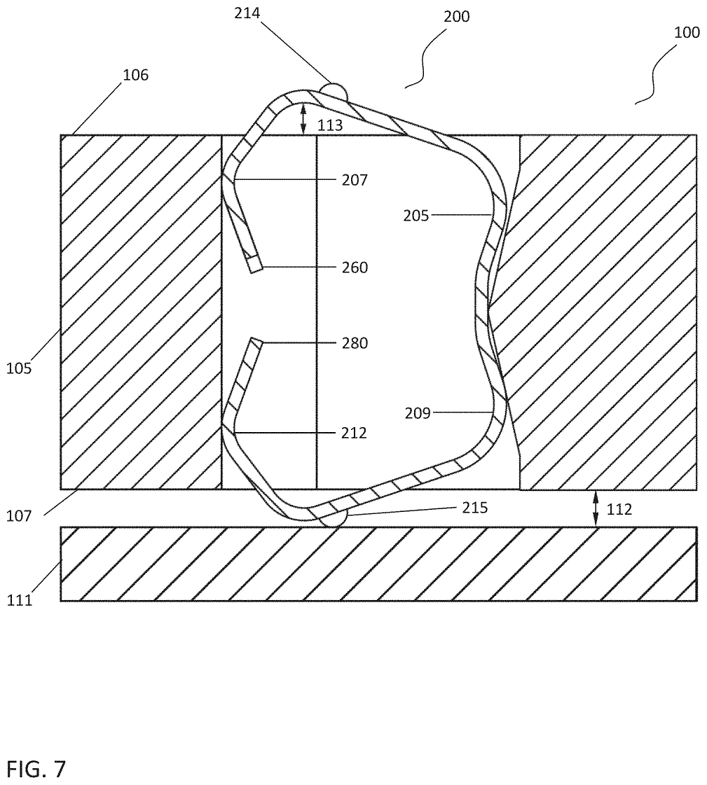

In one or more embodiments, the interposer assembly 100 may have one or more contacts 200 inserted and in the gravity down position as shown in FIG. 6. The interposer assembly 100 may then be placed on a lower substrate 111 as illustrated in FIG. 7. The lower substrate 111 may have a contact pad (not illustrated) located below each contact 200 for engagement with the lower dome 215, as illustrated. When the assembly is placed on substrate 111, the plate 105 may be lowered until the lower dome 215 engages the contact pad on the substrate, which creates an upward biasing force. As discussed herein, the upper 214 and lower 215 domes allow for a higher point-contact force at the contact pad of the substrate. Moreover, the domes also allow for easier alignment of the one or more mating contact pads with the one or more contacts, specifically the upper 214 or lower 215 domes on the contact 200.

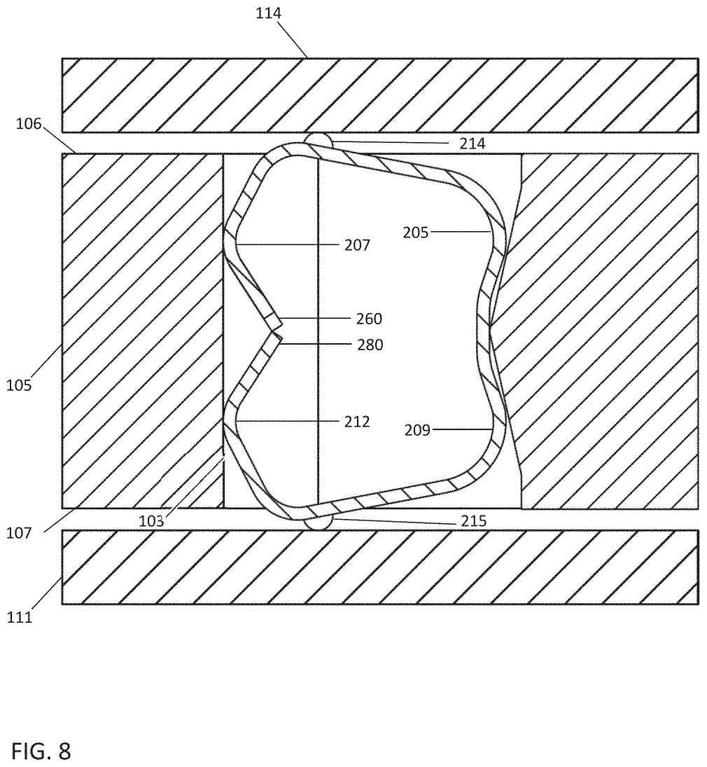

In a further embodiment, the upward biasing force may cause the lower support bend 212 to further engage the first end wall 103, thereby forcing the tip 280 to move in an upward and inward direction as shown in FIG. 8. In some embodiments, the contacts 200 may be raised up in passages 101 to an elevated position. The dialectic plate 105 may have a distance 112 above the lower substrate 111 as illustrated in FIG. 7. The contact 200 may be raised up in passage 101 with the rounded upper contact support 202 or the dome 214 at a distance 113 above the top of the plate which is greater than the distance 112 between the substrate 111 and the dielectric plate 105.

In some embodiments, when the contact 200 is in the position shown in FIG. 7, an upper substrate 114 is placed on the top of plate 105. As shown in FIG. 8, the upper substrate 114 may comprise one or more contact pads (not illustrated) that engage the upper dome 214. The upper substrate 114 may then be moved toward the lower substrate 111 to compress the domes 214 and 215, thereby compressing the rounded upper contact support 202 and the rounded lower contact support 203 into passage 101. The contact 200 may then be in the position shown in FIG. 8 when first engaged by upper substrate 114 and lower substrate 111. In another embodiment, the upper contact support 205 and the lower contact support 209 may slide along wall 105 thereby interacting with the protrusion 109. In one embodiment, the upper support bend 207 and the lower support bend 212 may be bent down into passage 101 with further lowering of the upper substrate 114.

Accordingly, in some embodiments and as shown in FIG. 8, as the contact 200 compresses due to the force applied at the upper substrate 114 and/or the lower substrate 111, the upper support bend 207 and the lower support bend 212 are forced toward each other while still being contained by wall 103. Thus, in at least one embodiment, the upper tip 260 may contact the lower tip 280. In a further embodiment, tips 260 and 280 may be formed with various interlocking or connection geometries as disclosed in further detail herein. In a further embodiment, as the upper support bend 207 and the lower support bend 212 move towards each other, the upper and lower domes 214 and 215 move or slide along the contact pads on both the upper substrate 114 and lower substrate 111, and thereby wipe or scratch the contact pads to ensure proper electrical connections between the two points of contact at the upper and lower domes 214 and 215.

In additional embodiments, as the contact 200 is compressed, the spine 201 may remain in approximately the same location during compression. As shown in FIG. 8, the upper contact support 205 and the lower contact support 209 contact the contact retention protrusion 109 of the second end wall 104, thereby creating tension in the contact 200. This further creates a biasing force in a direction distal to the contact retention protrusion 109. This biasing force ensures that the contact 200 is not moved or reoriented as forces are applied via the upper substrate 114 and the lower substrate 111.

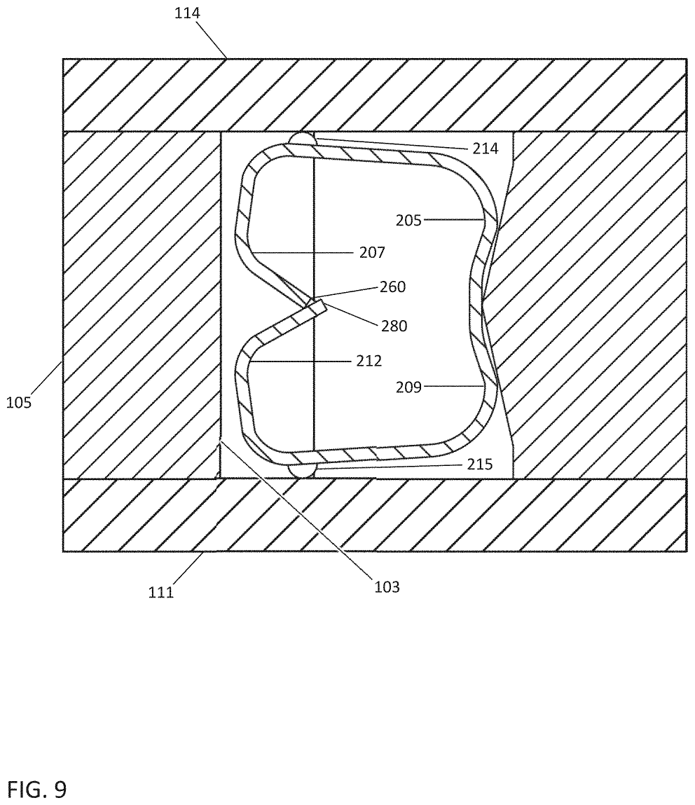

Referring now to FIG. 9, in some embodiments, further downward movement of the upper substrate 114 and/or upward movement of the lower substrate 111 may result in the substrates being located against the top 106 and bottom 107 surfaces of the dialectic plate 105, respectively. During this movement, the contact 200 may be further compressed causing the point of physical engagement between tips 260 and 280 to move inwardly toward the center of the contact (e.g., compare FIGS. 8 and 9). Thus, in some embodiments, the electrical connection between the tips 260 and 280 creates a redundant or second electrical circuit path (i.e., in additional to the path created by the spine 201 of the contact 200.

Referring briefly to FIG. 2, in some embodiments, a first continuous conductive circuit path may exist between the upper dome 214 and the lower dome 215 via the pathway created from the upper substrate 114 through the upper dome, the first upper flat spring arm 204, the upper contact support 205, the spine 201, the lower contact support 209, the first lower flat spring arm 210, and the lower dome to the contact point on the lower substrate 111. A second or redundant continuous conductive circuit path may exist between the upper dome 214 and the lower dome 215 via the pathway created from the upper substrate 114 through the upper dome, the rounded upper contact support 202, the second upper flat spring arm 206, the upper support bend 207, the upper end strip 208, the compression connection of the upper tip 260 and the lower tip 280, the lower end strip 213, the lower support bend 212, the second lower flat spring arm 211, the rounded upper contact support 203, and the lower dome to the contact point on the lower substrate 111.

As shown in FIG. 9, in a further embodiment, during compression of the contact 200, the upper support bend 207 and the lower support bend 212 may rotate out of engagement with wall 103. In some embodiments, the contacts 200 are free to move vertically in the passage. This freedom of vertical movement desirably equalizes the pressures at the top (e.g., where the upper dome 214 contacts the upper substrate 114) and bottom (e.g., where the lower dome 215 contacts the lower substrate 111) of the contact to ensure that a reliable electrical connection is formed between the contact pads on both substrates.

Thus, according to some embodiments, the upper dome 214 and/or the lower dome 215 may wipe or scrape along the contact pad of the upper substrate 114 and/or the lower substrate 111, which can improve the quality of the electrical connection. Over time, impurities, oxides, or contaminants may build up on either the contact surface or the pad and can impair the electrical connection. As should be understood by one of ordinary skill in the art, the redundant circuit paths described herein reduce electrical resistance between the upper substrate 114 and the lower substrate 111 to help reduce high speed inductance between contacts in plate 105.

In some embodiments, when the contact 200 is being compressed and the second redundant electrical connection between tip 260 and tip 280 is formed, variables inherent in the manufacture of interposer assemblies, their components, and the location of the components may affect the connection between the substrates. Generally, mating with contact pads (not shown) on opposing substrates (e.g., 111 and 114) is unlikely to be perfectly symmetrical. This is because, in some embodiments, the manufactured parts may have dimensional tolerances or design characteristics that may affect mating. In a further embodiment, the result of having these manufacturing variables is that during compression of the contact 200 and formation of the connections between tips 260 and 280, the upper 107 and lower 212 support bends may engage the end wall 103 at different times, such that tips may not align and perfectly deflect together.

As illustrated in FIG. 9, in some embodiments, the compressed contact 200 may include a first and second circuit path, described in detail herein, extending across the thickness of plate 105 from a first contact point (i.e., where the upper dome 214 contacts the upper substrate 114) to a second contact point (i.e., wherein the lower dome 215 contacts the lower substrate 111). The two connectivity paths substantially extend through the full length of the contact 200, which may eliminate any substantial antenna or stub portion of the contact being outside of the electrical path. Elimination of the stubs prevents radiation of current passing through the contact and, as a result, increases signal integrity at the contact.

As discussed herein, the tips 260 and 280 may not perfectly align during compression between the upper substrate 114 and the lower substrate 111 based on manufacturing tolerances. As would be understood by one of ordinary skill in the art, the upper and lower tips 260 and 280 could potentially slide off of each other or lose connection in another way if the tips are blunt and/or not interlocking. Accordingly, in some embodiments, the tips 260 and 280 may have corresponding interfaces that improve the connection strength of the tips and decrease the likelihood of a failed connection (i.e., where upper tip 260 and lower tip 280 do not touch and thus fail to create a conductive path).

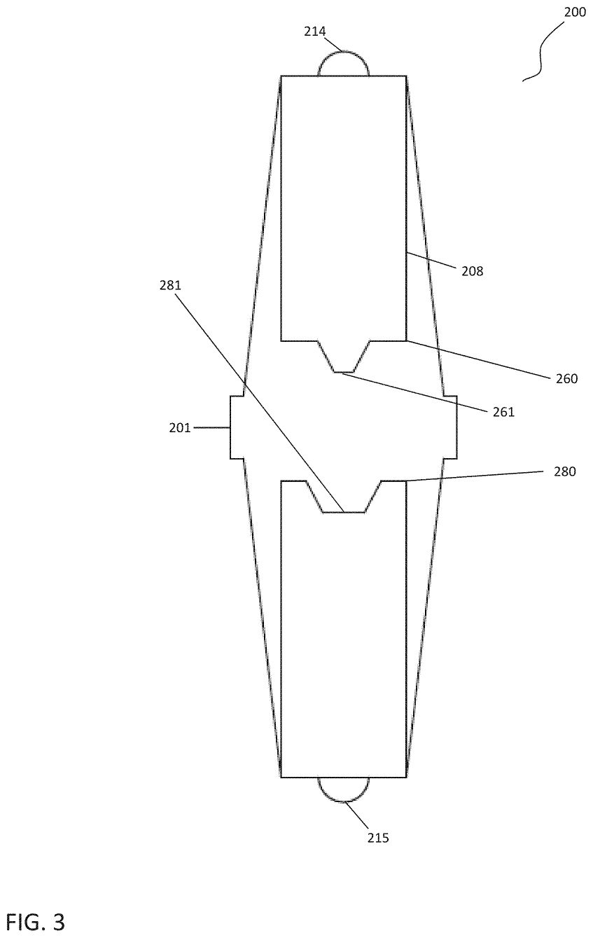

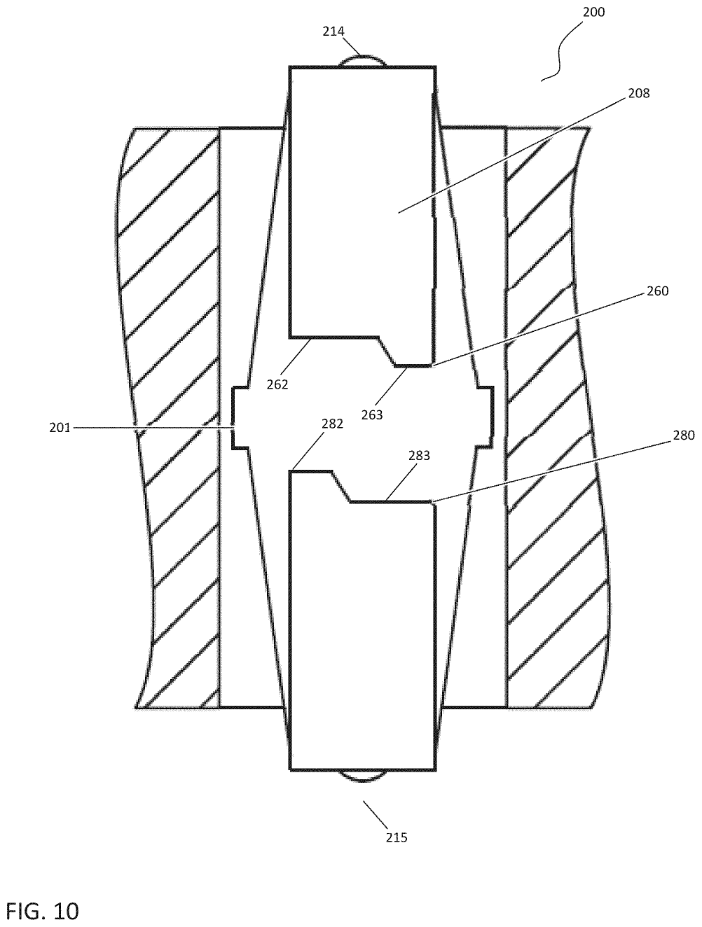

As shown in FIG. 3, the upper tip 260 may have one or more protrusions 261, which mate with a corresponding recession 281 in the lower tip 280 (or vice versa). Accordingly, in some embodiments, even if the upper tip 260 and the lower tip 280 do not perfectly align while moving in an inward direction, due to the compression of the contact 200, the interlocking nature of the upper and lower tips ensures that a consistent and long-term connection is maintained. It should be understood that the figures and description of the interlocking pattern and/or method of upper tip 260 and lower tip 280 may be of any form or corresponding shape. Accordingly, FIG. 10 illustrates an additional or alternative non-limiting embodiment where the upper tip 260 may have a lowered portion 262 and a raised portion 263, and the lower tip 280 may have a correspondingly shaped raised portion 282 and lowered portion 283. It should be understood that the number of raised/lowered areas and/or the number of protrusions and/or recesses may vary based on the specific situation and need.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A system for creating an electrical connection between two substrates comprising:
an upper substrate;
a lower substrate; and
a dielectric plate comprising:
one or more passages, wherein each passage has a first end wall and a second end wall, wherein at least one of the first end wall and the second end wall comprises a protrusion, and
one or more contacts, wherein each contact comprises:
an upper portion having an upper dome, a rounded upper contact support, and an upper tip having at least one protrusion,
a lower portion having a lower dome, a rounded lower contact support and a lower tip having at least one recess, wherein the at least one recess is complementary to the at least one protrusion, and
a spine portion connecting the upper portion and the lower portion,
wherein each contact is configured to fit a corresponding passage of the one or more passages, and
wherein the upper tip and the lower tip are configured to interlock with each other through movement of the upper and lower substrate, thereby creating an electrical path, when the one or more contacts are in a compressed state.

2. The system of claim 1, wherein the one or more contacts are in a compressed state when a sufficient vertically compressive force is applied to the upper dome and the lower dome by the upper substrate and the lower substrate, respectively.

3. The system of claim 1, wherein the upper dome and the lower dome are coated in a conductive plating.

4. The system of claim 1, wherein each contact has a thickness of about 0.0017 inches.

5. The system of claim 1, wherein:
the upper tip comprises at least one raised portion and at least two lowered portions, and
the lower tip comprises at least one lowered portion and at least two raised portions.

6. The system of claim 1, wherein:
the upper tip comprises at least one raised portion and at least one lowered portion, and
the lower tip comprises at least one raised portion and at least one lowered portion.

7. The system of claim 1, wherein the spine portion has a curvature.

8. The system of claim 1, wherein the curvature and the at least one protrusion align when the contact is inserted into the corresponding passage.

9. The system of claim 1, herein the at least one protrusion is symmetrical to either side of a plane parallel to the top or bottom of the dielectric plate.

10. The system of claim 1, wherein the upper dome and the lower dome contact and slide along the upper substrate and lower substrate, respectively, to improve a conductive connection.

11. The system of claim 1, wherein the one or more contacts further comprise an upper support bend and a lower support bend, wherein the upper support bend and the lower support bend contact at least one of the first end wall and the second end wall when inserted into the one or more passages.

12. The system of claim 11, wherein the upper support bend and lower support bend do not contact at least one of the first end wall and the second end wall when the one or more contacts are in a compressed state.

13. A contact for forming an electrical connection, the contact comprising:
an upper portion having an upper dome, a rounded upper contact support, and an upper tip having at least one protrusion;
a lower portion having a lower dome, a rounded lower contact support and a lower tip having at least one recess, wherein the at least one recess is complementary to the at least one protrusion; and
a spine portion connecting the upper portion and the lower portion,
wherein the upper tip and the lower tip are configured to interlock with each other ,through movement of the upper and lower substrate, when the contact is in a compressed state.

14. The contact of claim 13, wherein the contact is in a compressed state when a sufficient vertically compressive force is applied to the upper dome and the lower dome.

15. The contact of claim 13, wherein the upper dome and the lower dome are coated in a conductive plating.

16. The contact of claim 13, wherein the contact has a thickness of between 0.03 mm and 0.05 mm.

17. The contact of claim 13, wherein:
the upper tip comprises at least one raised portion and at least two lowered portions, and
the lower tip comprises at least one lowered portion and at least two raised portions.

18. The contact of claim 13, wherein:
the upper tip comprises at least one raised portion and at least one lowered portion, and
the lower tip comprises at least one raised portion and at least one lowered portion.

19. The system of claim 13, wherein the spine portion has a curvature.

20. The contact of claim 13, wherein the contact is formed from gold-coated beryllium copper.
